(19) United States
(12) Patent Application Publication
(10) Pub. No.: US 2007/0100869 A1
(43) Pub. Date: May 3, 2007

(54) Transferring specifications and providing an integration point for external tools to access the specifications

(76) Inventors: Gary Charles Doney, Sunnyvale, CA (US); Brian S. Dreher, San Jose, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/265,053

(22) Filed: Nov. 1, 2005

(51) Int. Cl. G06F 7/00

(52) U.S. Cl. 707/102

(57) ABSTRACT

Provided are techniques for using a specification. A first specification that was created in a portable data format with an archive tool is imported, wherein the specification indicates whether data is to be archived or retrieved, wherein the specification was created for execution at a first computing device, and wherein importing includes parsing information in the first specification to populate one or more data structures. A second specification is created using the one or more data structures, wherein the second specification may be executed at a second computing device which imported the first specification.

### BACKGROUND

1. Field

Embodiments of the invention relate to transferring specifications and providing an integration point for external tools to access the specifications.

2. Description of the Related Art

Data archiving tools, such as an IBM® DB2® Data Archive Expert tool or Tivoli® Storage Manager tool (both of which are available from International Business Machines Corporation), typically provide a way for users to specify selected parts of data (e.g., tables of a database) that they wish to archive on a given archive run. For example, when archiving data from a relational database, a user may create a specification that specifies a set of database tables, connection keys that link those tables, a WHERE clause of a Structured Query Language (SQL) SELECT statement to filter the selected rows, and target information detailing the form of the data to be archived (e.g., in tables or files) and location where the data should be archived. These specifications may be written for use on a first computing device, but the specifications may be useful for use on a second computing device that may include another installation of the same archiving tool. In some situations, a user recreates the specifications for the second computing device entirely anew.

Thus, there is a need in the art for transferring specifications (e.g., from one installation of the archiving tool to another) and providing an integration point for external tools to access the specifications.

### SUMMARY OF EMBODIMENTS OF THE INVENTION

Provided are a method, computer program product, and system for using a specification. A first specification that was created in a portable data format with an archive tool is imported, wherein the specification indicates whether data is to be archived or retrieved, wherein the specification was created for execution at a first computing device, and wherein importing includes parsing information in the first specification to populate one or more data structures. A second specification is created using the one or more data structures, wherein the second specification may be executed at a second computing device which imported the first specification.

### BRIEF DESCRIPTION OF THE DRAWINGS

Referring now to the drawings in which like reference numbers represent corresponding parts throughout:

FIG. 1 illustrates details of a computing device in accordance with certain embodiments.

FIG. 2 illustrates logic for creating an initial specification in accordance with certain embodiments.

FIG. 3 illustrates logic for importing a specification in accordance with certain embodiments.

FIG. 4 illustrates an example of a specification in the XML format in accordance with certain embodiments.

FIG. 5 illustrates logic for execution of a specification in accordance with certain embodiments.

FIG. 6 illustrates logic for use of a specification by another tool in accordance with certain embodiments.

FIG. 7 illustrates an architecture of a computer system that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

Embodiments enable creation of a specification with a portable data format (e.g., Extensible Markup Language (XML)) that encapsulates the specification information and also enables transfer (“export”) or receipt (“import”) of specification data through an archive tool specification API that has an import/export capability. The portable data format may be a human-readable format or other format.

The specification may be exported from an archive tool to a local file system at a first computing device, transferred to a local file system at a second computing device, and imported to an archive tool at the second computing device. Thus, the specification may be “exported” from an archive tool at the first computing device and “imported” to an archive tool at the second computing device.

In certain embodiments, XML is used as the portable data format to encapsulate the specification data. Although examples may refer to XML, embodiments are not intended to be limited to XML specifications and embodiments are applicable to any portable data format structured to enable parsing of information written in that portable data format. Other examples of portable data formats include HyperText Markup Language (HTML) and Rich Text Format (RTF).

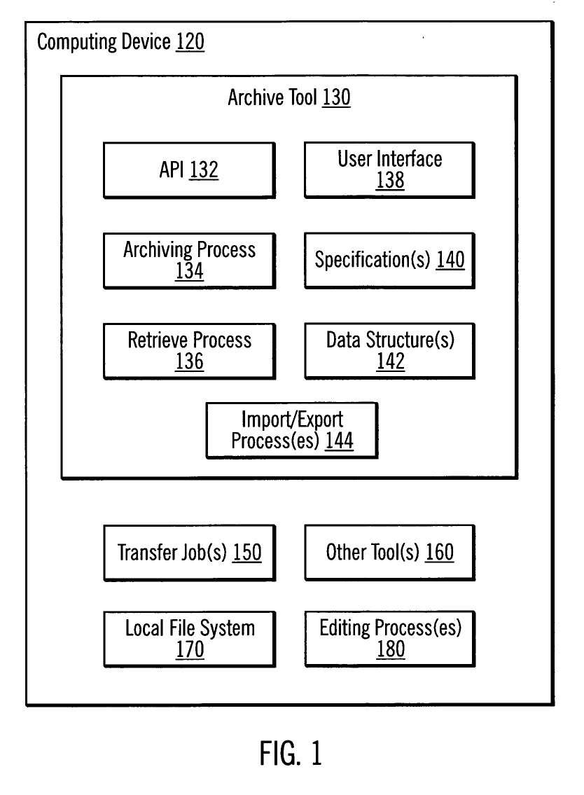

FIG. 1 illustrates details of a computing device 120 in accordance with certain embodiments. The computing device 120 includes an archive tool 130, one or more transfer jobs 150, and may include one or more other tools 160 (e.g., analysis tools that examine frequency of archiving data for compliance with record retention requirements). The transfer jobs 150 may be described as including export jobs that would be executed at a first computing device and corresponding import jobs that would be executed at a second computing device to which a specification 140 is to be transferred. The computing device 120 is coupled to a local file system 170. The import/export processes 144 export a specification 140 from the archive tool 130 to the local file system 170 and import a specification 140 to the archive tool 130 from the local file system 170. Also, the computing device 120 may include one or more editing processes 180 (e.g., a text editor) for editing the specification 140.

The archive tool 130 includes an Application Programming Interface (API) 132, an archiving process 134, a retrieve process 136, and a user interface 138. The archive tool 130 may also include one or more specifications 140 and one or more data structures 142 associated with the specification 140. The one or more specifications 140 may include specifications created at the computing device 120 or imported from another computing device. The specifications 140 may also include archive specifications for archiving data and retrieve specifications for retrieving data. The archiving process 134 uses an archive specification 140 to archive data from a source location to a target location, while the retrieve process 136 uses a retrieve specification 140 to retrieve archived data by moving the archived data back to the original source location, or to another location specified by the user. That is, the retrieve process 136 uses data that has been previously archived as source data. Certain embodiments provide the capability to use a retrieve specification 140 to retrieve the data archived from multiple archive runs in one retrieve run. The archive tool 130 and includes one or more import/export processes 144.

The local file system 170 may comprise an array of storage devices, such as Direct Access Storage Devices (DASDs), Just a Bunch of Disks (JBOD), Redundant Array of Independent Disks (RAID), virtualization device, etc.

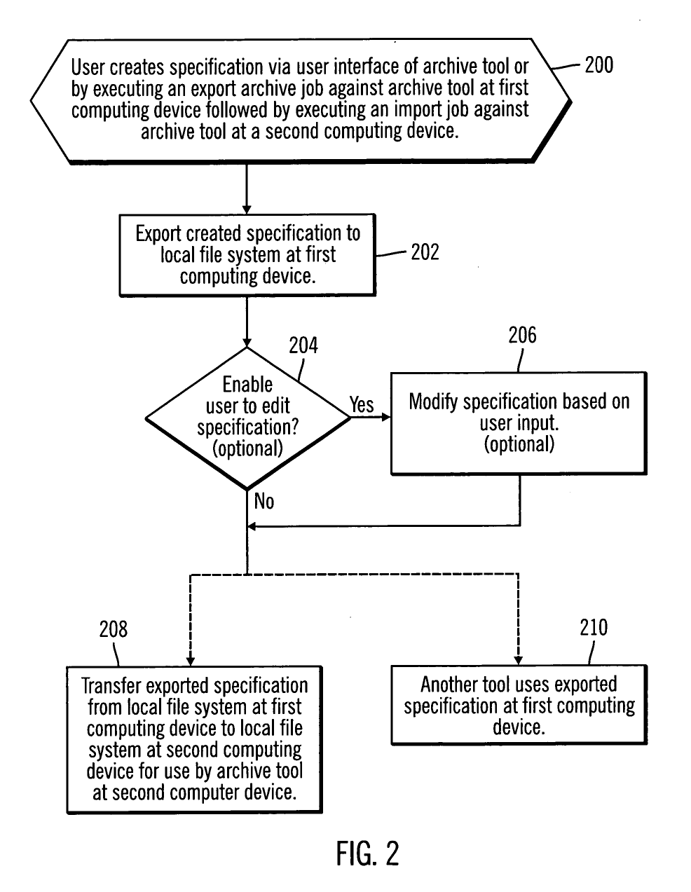

FIG. 2 illustrates logic for creating an initial specification 140 in accordance with certain embodiments. Control begins at block 200 with a user creating a specification 140 either by inputting information into a user interface 138 of the archive tool 130 or by executing an export job (e.g., export job 1xx) against the archive tool 130 at a first computing device, followed by execution of an import job (e.g., import job 1xx) against the archive tool at a second computing device. In particular, the archive tool 130 provides a user interface 138 to enable a user to provide data to the archive tool 130 for creation of the specification 140. The provided data may include, for example, a set of database tables, connection keys that link those tables, a WHERE clause of a SELECT statement to filter the selected rows, and target information detailing the form of the data to be archived (e.g., in tables or files) and location where the data should be archived. The SELECT statement may be a SQL statement or a statement in another language or format. The transfer job 150 is executed via a command line interface of the computing device 120 to collect information from the archive tool 130 (e.g., from files or tables maintained by the archive tool 130) and generate the specification 140. In certain embodiments, the user is provided with a template for the transfer job 150, and the user enters certain parameters into the template to customize the transfer job 150 and executes the customized transfer job 150.

In block 202, the archive tool 130 exports the created specification 140 to the local file system 170 at the first computing device. In certain embodiments, the specification 140 is created in human-readable format. In certain embodiments, the specification 140 is exported in encrypted or binary format to the local file system 170 so that the content is not user-readable or editable in the encapsulated form by the user at a computing device. In certain embodiments, the specification 140 is exported in human-readable format, thereby enabling the user to modify the specification 140 at the computing device to which the specification 140 is exported. The specification 140 may be modified before being transferred to another computing device, before being used by another tool 160 at the computer device at which the specification 140 was created, and/or may be modified after being transferred to another computing device and before being imported into the archive tool 130 at that other computing device.

Optionally, in block 204, an editing process 180 determines whether a user may edit the specification 140. In certain embodiments, a user who wishes to edit the specification 140 invokes the editing process 180. In certain embodiments, users having a certain level of authority are allowed to create and edit the specification 140. In certain embodiments, an indicator (e.g., a bit or flag) may be set (e.g., within the specification 140) by, for example, a system administrator or the creator of the specification 140 to indicate whether any user may edit the specification 140. If the user may edit the specification 140, processing continues to block 206, otherwise, processing continues to block 208. In block 206, the editing process 180 modifies the specification 140 based on user input. In certain embodiments, if the specification 140 was exported in binary format, the specification 140 may not be edited, and, if the specification 140 was exported in human-readable format and the user is authorized to edit the specification 140, the specification 140 may be edited using the editing process 180. In certain alternative embodiments, if the user is authorized to edit the specification 140 and the specification is in binary format, the specification 140 may be converted to human-readable format for editing.

Once the specification 140 has been exported to the local file system 170 and, optionally, edited, the specification 140 may be transferred from the local file system 170 at the first computing device to a local file system of a second computing device for use by an archive tool or other tools at the second computing device (block 208) and/or may be used by another tool 160 at the first computing device (block 210).

Any computing device (e.g., computing device 120) may act as the first computing device at which the specification is created and/or as the second computing device to which a created specification is transferred. The transfer between local file systems may be completed in any manner (e.g., by copying the specification 140 to a computer readable media, such as a floppy disk or CD-ROM, and then copying the specification 140 to a second computer device).

With reference to block 208, for example, the other tool 160 may want to maintain a record of which tables of a database have been archived. Because the specification 140 is in a portable data format, the tool 160 is able to use the information in the specification 140 by either reading the portable data format directly or converting the portable data format to a data format understood by the tool 160.

Thus, once the processing of blocks 202-206 is completed, processing may continue to block 208 and/or block 210.

In certain embodiments, the specification 140 is created using the user interface 138 of the archive tool 130 on a first computing device. The specification 140 is exported in a portable data format to a local file system 170 on the first computing device. Then, the specification 140 in the portable data format is transferred to the local file system of the second computing device. At the second computing device the specification 140 in the portable data format is imported into the archive tool on the second computing device.

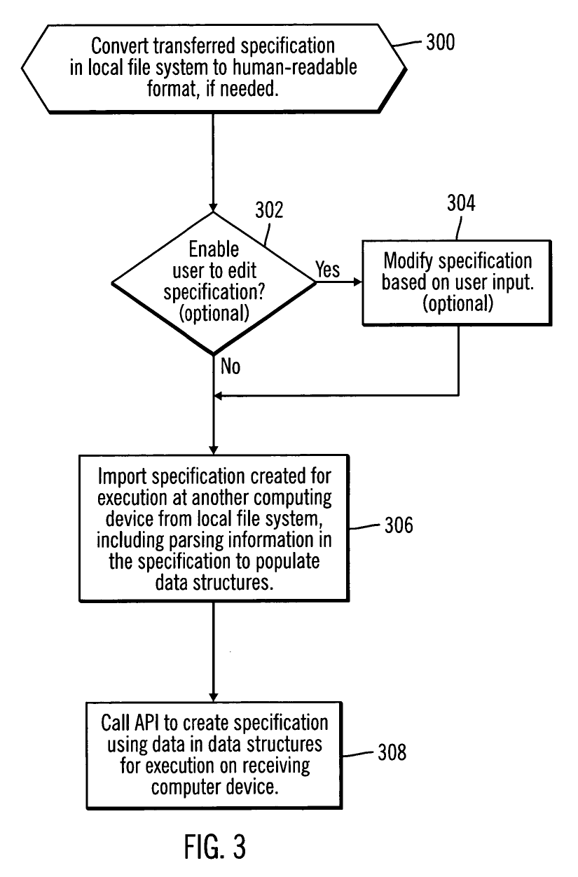

FIG. 3 illustrates logic for importing a specification 140 in accordance with certain embodiments. Control begins at block 300 with the import/export processes 144 converting a transferred specification 140 in a local file system 170 to human-readable format, if needed. In particular, if the specification 140 is transferred in binary format, the specification 140 is converted to human-readable format.

In certain embodiments, the specification 140 may be edited after being transferred. Therefore, optionally, in block 302, an editing process 180 determines whether the user may edit the specification 140. In certain embodiments, users having a certain level of authority are allowed to create and edit the specification 140. In certain embodiments, an indicator (e.g., a bit or flag) may be set (e.g., within the specification 140) by, for example, a system administrator or the creator of the specification 140 to indicate whether any user may edit the specification 140. If the user may edit the specification 140, processing continues to block 304, otherwise, processing continues to block 306. In block 304, the editing process 180 modifies the specification 140 based on user input.

In block 306, an archive tool 130 imports the transferred specification 140 created for execution at another computing device from the local file system 170. In certain embodiments, an import job 150 may be run against the archive tool 130 so that the archive tool 130 becomes aware of the specification 140. Because a retrieve specification 140 is linked to a parent specification 140 (i.e., a previously run archive specification 140), the import process does a lookup of the corresponding archive specification 140 based on the specification name and type during the import of the retrieve specification 140. During the import process, the archive tool 130 parses information in the specification 140 to populate data structures 142.

In block 308, the archive tool 130 calls the API 132 to create the specification 140 using data in the data structures, wherein the created specification 140 may be executed on the receiving computer device (rather than the computer device for which the specification 140 was originally written).

The following is a sample API 132 in accordance with certain embodiments:

```
public void createDefinitionInfoForArchive(
        Vector pLoc,
        Vector pTbSrc,
        Vector pConnKeys,
        Vector pIndx,
        String pSqlWhere,
        Vector pTablemaps,
        boolean pAutodelete,
        boolean pIsValid,
        boolean pOverRide,
        String pDeferredDelVal)
```

In the sample API, the pLoc parameter holds information about source and target database locations (e.g., a hostname, port, database name, etc). The pTbSrc parameter describes source table information. The pConnKeys parameter describes connection keys that are used to join the source tables of the archive unit. An archive unit may be described as the name of a collection of linked tables. The pIndx parameter describes columns used to uniquely identify rows in the source tables and to create indexes on the target tables. The pSqlWhere parameter provides a SQL WHERE clause that provides a filter on the rows of a table to be archived. The pTablemaps parameter describes target table information (e.g., mappings from source tables to target tables and information about the target tables). The pAutodelete parameter indicates whether data from the source of the archive is to be deleted automatically either immediately after the archive run or at a later time. The pIsValid parameter describes whether the specification needs to be a valid specification or may be a “partially defined” specification. In certain embodiments, if the specification 140 is not valid, users are allowed to import the specification 140 in an invalid state (i.e., a “partially defined” state), and then the user is allowed to edit the partially defined specification 140 until the specification 140 is validated. The pOverRide parameter allows certain validation checks to be relaxed from being a fatal error to becoming a warning. The pDeferredDelVal parameter indicates whether orphan or data change detection checking should be utilized during the delete process. In the sample API, the boolean parameters may be, for example, flags.

The API 132 of the archive tool 130 validates the data in the imported specification 140. That is, the validating API 132 ensures that the imported specification information is valid on the installation of the archive tool 130 that imports the specification 140. In certain embodiments, the portable data format is XML, and “valid” refers to the specification 140 being well-formed and referring to actual tables and columns that exist and can therefore be run. For example, the API 132 of the archive tool 130 checks that source tables that are specified exist on the database. In certain embodiments, if the specification 140 is not valid, the API 132 does not create the specification 140. In certain embodiments, if the specification 140 is not valid, users are allowed to import the specification 140 in an invalid state (i.e., a “partially defined” state), and then the user is allowed to edit the partially defined specification 140 until the specification 140 is validated.

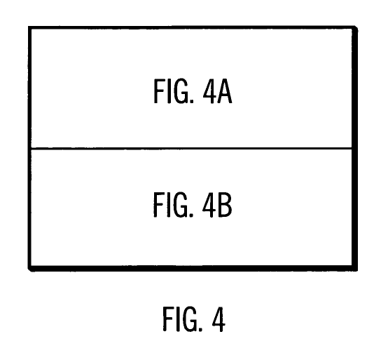

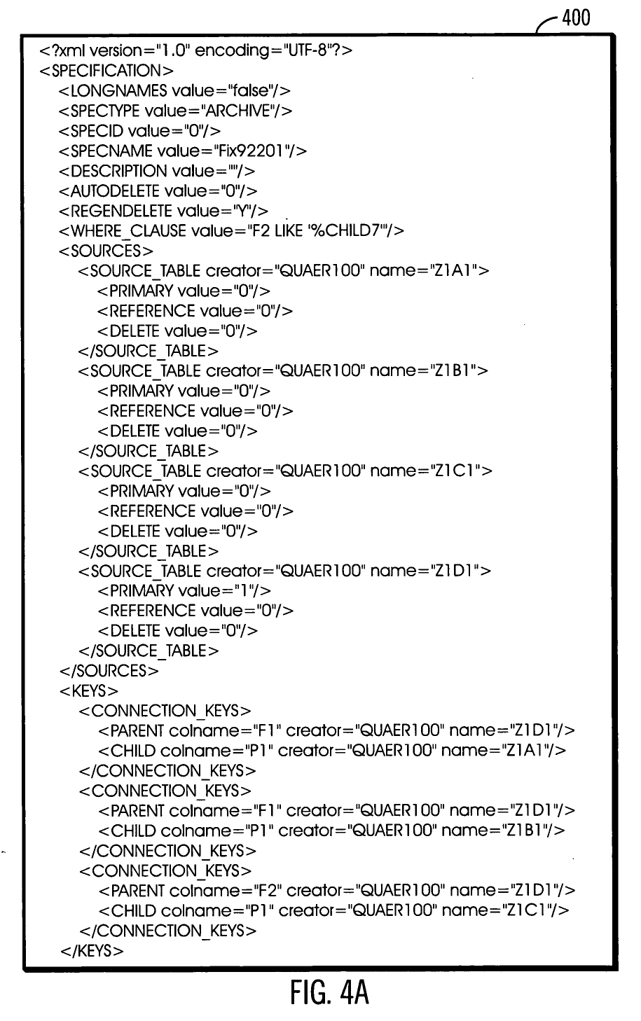

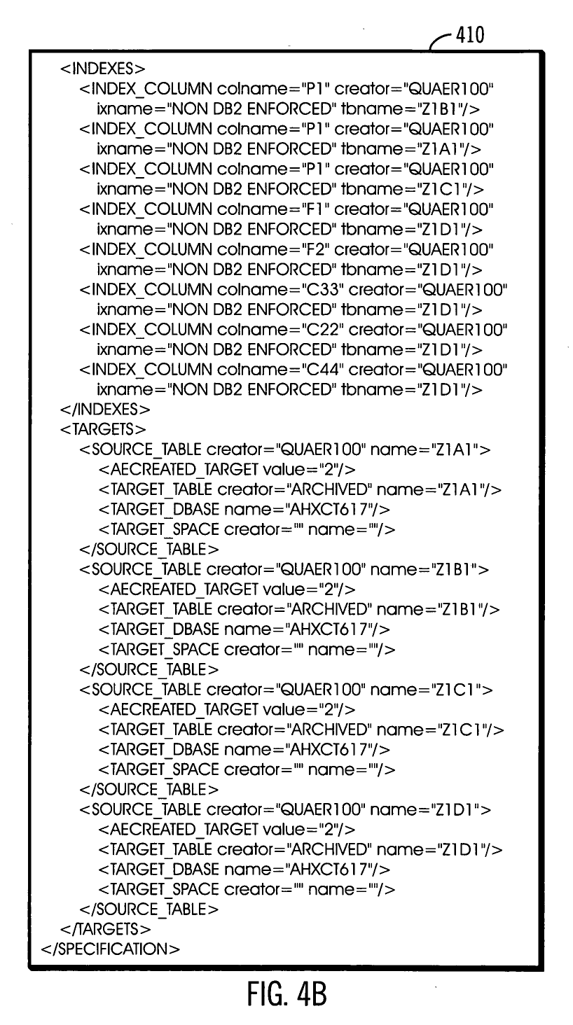

FIG. 4 illustrates an example of a specification 400, 410 in the XML format in accordance with certain embodiments. FIG. 4 is illustrated with FIGS. 4A and 4B. In FIG. 4A, a SPECTYPE field indicates whether the specification 400, 410 is for an archive or a retrieve. In this example, the SPECTYPE filed indicates that the specification 400, 410 is for an archive.

Table A illustrates example specification types along with sources and targets of data in accordance with certain embodiments. For each source and target, one or more tables or files may be specified. The retrieve specifications (i.e., specifications to retrieve data) move data in the opposite direction of a corresponding, previously executed archive specification (i.e., specifications to archive data). For the Second-Level Archive specification type, the source may be one or more archive tables generated with an archive run of a specification specifying the Table Archive specification type. Also, a File Retrieve specification may retrieve data from the target of either a File Archive specification type or a Second-Level Archive specification type.

TABLE A

| Specification Type | Source of Data | Target for Data |
|---|---|---|
| Table Archive | Table(s) | Archive Table(s) |
| | | (same computing |
| | | device) |
| Remote Table Archive | Table(s) | Archive Table(s) |
| | | (different computing |
| | | device) |
| File Archive | Table(s) | File(s) (same |
| | | computing device) |
| Second-Level Archive | Archive Table(s) | File(s) (same |
| | (from a previously | computing system) |
| | run table archive) | |
| Table Retrieve | Archive table(s) | Table(s) (same |
| | (from a previously | computing system) |
| | run table archive) | |
| Remote Table Retrieve | Archive table (from a | Table(s) (different |
| | previously run remote | computing system) |
| | table archive) | |
| File Retrieve | File (from a | Table(s) (same |
| | previously run file or | computing system) |
| | second-level archive) | |

In FIG. 4, a SPECID field indicates a specification identifier, and a SPECNAME field indicates a specification name. The DESCRIPTION field enables the creator of the specification 400, 410 to include descriptive information about the specification 400, 410. The AUTODELETE field indicates whether data from the source of the archive is to be deleted automatically either immediately after the archive run or at a later time. The REGENDELETE flag indicates whether orphan or data change detection checking should be utilized during the delete process. The WHERE_CLAUSE provides a filter on the rows of a table to be archived.

The SOURCE section describes the source data, while the TARGET section describes the target data. In particular, in the SOURCE section, for each source, a SOURCE_TABLE field indicates a schema and table name, a PRIMARY field indicates a starting point table, a REFERENCE field indicates a junction table that is used to link other tables to form an archive unit, and a DELETE field indicates whether information from the source table(s) is to be deleted after the archive.

In the TARGET section, for each corresponding source, a SOURCE_TABLE field indicates a source schema and table name, an AECREATED_TARGET field indicates whether a target table was created by the user or should be created by the archive tool 130, a TARGET_TABLE field indicates a target schema and table name, a TARGET_DBAASE indicates a database in which archived data is to be stored, and a TARGET_SPACE indicates a table space (which may be described as a portion of storage that stores tables).

The KEYS section describes the connection keys that are used to join the source tables of the archive unit, which is the name of a collection of linked tables. The INDEXES section provides columns used to uniquely identify rows in the source tables and to create indexes on the target tables. Other specifications 140 may include the same and/or different fields.

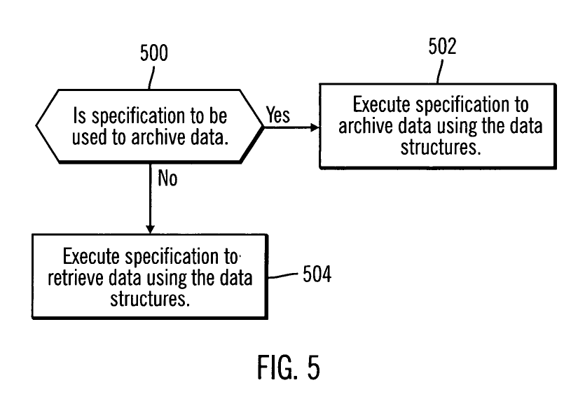

The portable data format provides users with the capability to import and export both specifications 140 that archive data and specifications 140 that retrieve data from an archive that has been previously created with the archiving tool 130. FIG. 5 illustrates logic for execution of a specification 140 in accordance with certain embodiments. Control begins at block 500 with the archive tool 130 determining whether the specification 140 is to be used to archive or retrieve. This determination is made using information in the specification 140. In certain embodiments, the specification 140 includes a specification type, such as those listed in Table A, which indicates whether to archive or retrieve data. If data is to be archived, processing continues to block 502, otherwise, data is to be retrieved and processing continues to block 504. In block 502, the archive process 134 of the archive tool 130 archives data using the data structures 142. In block 504, the retrieve process 136 of the archive tool 130 retrieves data using the data structures 142.

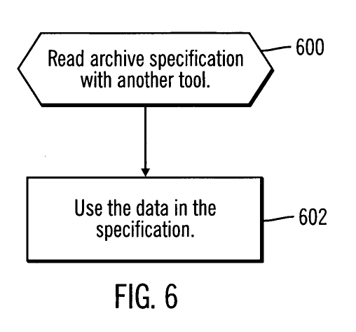

FIG. 6 illustrates logic for use of a specification 140 by another tool 160 in accordance with certain embodiments. Control begins at block 600 with another tool 160 reading a specification 140. In block 602, the tool 160 uses the data in the specification 140. The portable data format is used to create the specification 140 so that the specification 140 may be used by other tools 160 to create, import, or analyze the specification 140. This provides a technique to loosely couple an archive tool 130 with other tools 160.

Thus, embodiments consist of a portable data format (e.g., XML) import/export mechanism for the archive tool 130, which utilizes a validating API 132 to enable users to export a specification 140 from a first installation of the archive tool 130 at one computing device to a second installation of the archive tool 130 at another computing device. Embodiments utilize the validating API 132 to perform validation checking on the specification 140 as the specification 140 is imported into the second installation of the archive tool 130.

Certain embodiments write the specification 140 in binary format so that the specification 140 is not human-readable and, therefore, not editable by the user. However, a specification 140 in binary format may be loaded by the import API 132 after being converted back to a human-readable format (e.g., character data) prior to the import. It would also be possible to export the data in a human-readable format to enable users to edit the specification 140 (either directly or with the aid of another tool that understands the specification format).

Thus, embodiments provide users with a technique to modify the exported specification 140 prior to importing the specification back to another version of the archive tool 130. That is, a user could change the values of certain fields to modify the specification 140 so that the specification 140 refers to valid constructs on the second computing device. As an example, the schema names for the tables on the second computing device may be different from the schema names for the tables on the first computing device. With embodiments, the user is able to modify the schema names in the specification 140 exported from the first computing device before attempting to import the specification 140 on the second computing device into the archive tool 130. This enables the specification 140 to be valid after being imported because the modified specification 140 refers to tables with the correct schema names on the second computing device.

An alternative technique for transferring a specification 140 between two computing devices would be to provide a way for one installation of the tool to programmatically transfer the specification 140 from one installation of the tool to another, for example, by writing the specification 140 to another installation as a stream over a Transmission Control Protocol/Internet Protocol (TCP/IP) socket. However, unlike such a direct transfer, embodiments do not require any direct connectivity between the two archive tool installations. Further, by using a portable data format (e.g., the well-known file format XML), various application tools may be used to either create specifications 140 or to import the specification data, thereby providing a loose coupling among different tools understanding the specification format.

### Additional Embodiment Details

The described operations may be implemented as a method, computer program product or apparatus using standard programming and/or engineering techniques to produce software, firmware, hardware, or any combination thereof.

Each of the embodiments may take the form of an entirely hardware embodiment, an entirely software embodiment or an embodiment containing both hardware and software elements. The embodiments may be implemented in software, which includes but is not limited to firmware, resident software, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The described operations may be implemented as code maintained in a computer-usable or computer readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a rigid magnetic disk, an optical disk, magnetic storage medium (e.g., hard disk drives, floppy disks, tape, etc.), volatile and non-volatile memory devices (e.g., a random access memory (RAM), DRAMs, SRAMs, a read-only memory (ROM), PROMs, EEPROMs, Flash Memory, firmware, programmable logic, etc.). Current examples of optical disks include compact disk—read only memory (CD-ROM), compact disk—read/write (CD-R/W) and DVD.

The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

A computer program product may comprise computer useable or computer readable media, hardware logic, and/or transmission signals in which code may be implemented. Of course, those skilled in the art will recognize that many modifications may be made to this configuration without departing from the scope of the embodiments, and that the computer program product may comprise any suitable information bearing medium known in the art.

The term logic may include, by way of example, software, hardware, firmware, and/or combinations of software and hardware.

Certain embodiments may be directed to deploying computing infrastructure by a person or automated processing integrating computer-readable code into a computing device, wherein the code in combination with the computing device is enabled to perform the operations of the described embodiments.

The logic of FIGS. 2, 3, 5, and 6 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIGS. 2, 3, 5, and 6 may be implemented in software, hardware, programmable and non-programmable gate array logic or in some combination of hardware, software, or gate array logic.

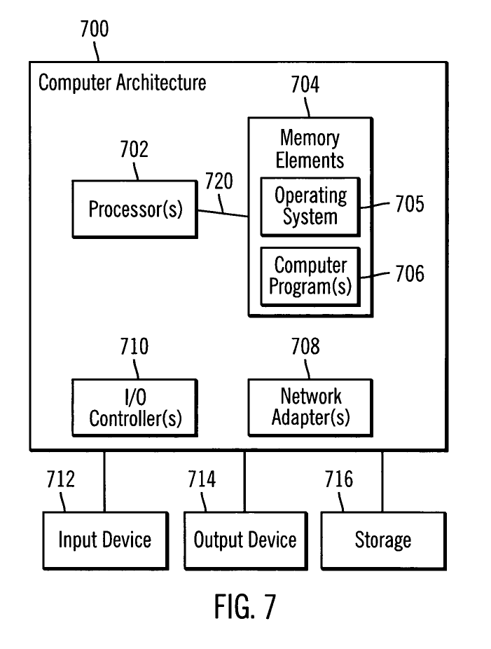

FIG. 7 illustrates a system architecture 700 that may be used in accordance with certain embodiments. Client computer 100 and/or server computer 120 may implement system architecture 700. The system architecture 700 is suitable for storing and/or executing program code and includes at least one processor 702 coupled directly or indirectly to memory elements 704 through a system bus 720. The memory elements 704 may include local memory employed during actual execution of the program code, bulk storage, and cache memories which provide temporary storage of at least some program code in order to reduce the number of times code must be retrieved from bulk storage during execution. The memory elements 704 include an operating system 705 and one or more computer programs 706.

Input/Output (I/O) devices 712, 714 (including but not limited to keyboards, displays, pointing devices, etc.) may be coupled to the system either directly or through intervening I/O controllers 710.

Network adapters 708 may also be coupled to the system to enable the data processing system to become coupled to other data processing systems or remote printers or storage devices through intervening private or public networks. Modems, cable modem and Ethernet cards are just a few of the currently available types of network adapters 708.

The system architecture 700 may be coupled to storage 716 (e.g., a non-volatile storage area, such as magnetic disk drives, optical disk drives, a tape drive, etc.). The storage 716 may comprise an internal storage device or an attached or network accessible storage. Computer programs 706 in storage 716 may be loaded into the memory elements 704 and executed by a processor 702 in a manner known in the art.

The system architecture 700 may include fewer components than illustrated, additional components not illustrated herein, or some combination of the components illustrated and additional components. The system architecture 700 may comprise any computing device known in the art, such as a mainframe, server, personal computer, workstation, laptop, handheld computer, telephony device, network appliance, virtualization device, storage controller, etc.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

What is claimed is:

1. A computer-implemented method for using a specification, comprising:
importing a first specification that was created in a portable data format with an archive tool, wherein the specification indicates whether data is to be archived or retrieved, wherein the specification was created for execution at a first computing device, and wherein importing includes parsing information in the first specification to populate one or more data structures; and
creating a second specification using the one or more data structures, wherein the second specification may be executed at a second computing device which imported the first specification.

2. The method of claim 1, wherein the first specification is transferred to a local file system at the second computing device from a local file system at the first computing device and wherein the transferred specification is in binary format, further comprising:
converting the specification to human-readable format.

3. The method of claim 1, further comprising:
determining whether a user may edit the first specification; and
in response to determining that the user may edit the first specification, modifying the specification in response to user input.

4. The method of claim 1, wherein the second specification is created by calling an Application Programming Interface (API).

5. The method of claim 1, further comprising:
creating the first specification at the first computing device;
exporting the first specification to a local file system at the first computing device; and
transferring the first specification from the local file system at the first computing device to a local file system at the second computing device, wherein the first specification is imported from the local file system at the second computing device.

6. The method of claim 1, further comprising:
in response to determining that the second specification is to be used to archive data, archiving data; and
in response to determining that the second specification is to be used to retrieve data, retrieving data.

7. The method of claim 1, further comprising:
under control of an analysis tool, reading the first specification; and
using the data in the specification to perform analysis.

8. A computer program product for using a specification comprising a computer useable medium including a computer readable program, wherein the computer readable program when executed on a computer causes the computer to:
import a first specification that was created in a portable data format with an archive tool, wherein the specification indicates whether data is to be archived or retrieved, wherein the specification was created for execution at a first computing device, and wherein importing includes parsing information in the first specification to populate one or more data structures; and
create a second specification using the one or more data structures, wherein the second specification may be executed at a second computing device which imported the first specification.

9. The computer program product of claim 8, wherein the first specification is transferred to a local file system at the second computing device from a local file system at the first computing device, wherein the transferred specification is in binary format, and wherein the computer readable program when executed on a computer causes the computer to:
convert the specification to human-readable format.

10. The computer program product of claim 8, wherein the computer readable program when executed on a computer causes the computer to:
determine whether a user may edit the first specification; and
in response to determining that the user may edit the first specification, modify the specification in response to user input.

11. The computer program product of claim 8, wherein the second specification is created by calling an Application Programming Interface (API).

12. The computer program product of claim 8, wherein the computer readable program when executed on a computer causes the computer to:
create the first specification at the first computing device;
export the first specification to a local file system at the first computing device; and
transfer the first specification from the local file system at the first computing device to a local file system at the second computing device, wherein the first specification is imported from the local file system at the second computing device.

13. The computer program product of claim 8, wherein the computer readable program when executed on a computer causes the computer to:
in response to determining that the second specification is to be used to archive data, archive data; and
in response to determining that the second specification is to be used to retrieve data, retrieve data.

14. The computer program product of claim 8, wherein the computer readable program when executed on a computer causes the computer to:
under control of an analysis tool, read the first specification; and
use the data in the specification to perform analysis.

15. A system for using a specification, comprising:
logic capable of performing operations, the operations comprising:
importing a first specification that was created in a portable data format with an archive tool, wherein the specification indicates whether data is to be archived or retrieved, wherein the specification was created for execution at a first computing device, and wherein importing includes parsing information in the first specification to populate one or more data structures; and
creating a second specification using the one or more data structures, wherein the second specification may be executed at a second computing device which imported the first specification.

16. The system of claim 15, wherein the first specification is transferred to a local file system at the second computing device from a local file system at the first computing device, wherein the transferred specification is in binary format, and wherein the operations further comprise:
converting the specification to human-readable format.

17. The system of claim 15, wherein the operations further comprise:
determining whether a user may edit the first specification; and
in response to determining that the user may edit the first specification, modifying the specification in response to user input.

18. The system of claim 15, wherein the second specification is created by calling an Application Programming Interface (API).

19. The system of claim 15, wherein the operations further comprise:
creating the first specification at the first computing device;
exporting the first specification to a local file system at the first computing device; and
transferring the first specification from the local file system at the first computing device to a local file system at the second computing device, wherein the first specification is imported from the local file system at the second computing device.

20. The system of claim 15, wherein the operations further comprise:
in response to determining that the second specification is to be used to archive data, archiving data; and
in response to determining that the second specification is to be used to retrieve data, retrieving data.

21. The system of claim 15, wherein the operations further comprise:
under control of an analysis tool, reading the first specification; and
using the data in the specification to perform analysis.
